(19) United States
(12) Patent Application Publication
(10) Pub. No.: US 2026/0005810 A1
(43) Pub. Date: Jan. 1, 2026

(54) METHOD AND SYSTEM FOR DYNAMICALLY ALLOCATING RESOURCES IN MASSIVE MULTIPLE-INPUT MULTIPLE-OUTPUT (MIMO) SYSTEMS

(71) Applicant: Telefonaktiebolaget LM Ericsson (publ), Stockholm (SE)

(72) Inventors: Sairamesh NAMMI, Stockholm (SE); Darshan Arvind Patil, Stockholm (SE)

(21) Appl. No.: 19/127,008

(22) PCT Filed: Nov. 5, 2022
(86) PCT No.: PCT/IB2022/060656

§ 371 Date: May 2, 2025

(51) Int. Cl. H04L 5/00; H04B 7/06

(52) U.S. Cl. CPC H04L 5/0048; H04B 7/0626

(57) ABSTRACT

A method performed by a user equipment (UE) for dynamically allocating data transmission resources in a massive multiple input multiple output (MEMO) system is disclosed. The UE receives from a network node at least one initial channel state information reference signal (CSI-RS) resource set comprising at least an initial number of ports. A sounding reference signal (SRS) is transmitted to the network node. The network node transmits to the UE a dynamically allocated number of CSI-RS ports, or alternatively, a trigger state for a predefined CSI-RS resource set and a beamformed CSI-RS. The UE computes one or more parameters corresponding to channel state information (CSI) from the beamformed CSI-RS. A CSI report comprising the one or more parameters is transmitted to the network node. The UE then receives user data over a data traffic channel using the dynamically allocated number of CSI-RS ports, or alternatively the pre-defined CSI-RS resource set.

### FIELD

This invention is related to wireless communication systems, in particular, methods related to improving massive multiple input, multiple output (MIMO) systems with reciprocity.

### BACKGROUND

To meet the huge demand for data centric applications in wireless telecommunications systems, the 3^{rd} Generation Partnership Project (3GPP) has extended the 4G standards to 5G, also referred to as New Radio (NR) access. The following are some example requirements for 5G networks:
Data rates of several tens of megabits per second should be supported for tens of thousands of users;
1 gigabit per second is to be offered simultaneously to tens or hundreds of users on the same office floor;
Several hundreds of thousands of simultaneous connections are to be supported for massive sensor deployments;
Spectral efficiency should be significantly enhanced compared to 4G;
Coverage should be improved;
Signaling efficiency should be enhanced; and
Latency should be reduced significantly compared to LTE (Long Term Evolution) networks.

It is well known that MIMO systems can significantly increase the data carrying capacity of wireless systems. For these reasons, MIMO is an integral part of the 3^{rd} and 4^{th} generation wireless systems. 5G systems will also employ MIMO systems also called massive MIMO systems (hundreds of antennas at the Transmitter side and Receiver side). Typically, with a (Nₜ, Nᵣ), where Nₜ denotes the number of transmit antennas and Nᵣ denotes the number of receive antennas, the peak data rate multiplies with a factor of Nₜ over single antenna systems in a rich scattering environment.

In reciprocity-based precoding, the precoder is computed at the base station. However, the modulation and coding scheme (MCS) needed for scheduling is obtained from the channel quality indicator (CQI) measurements from the user equipment (UE). This is because the downlink interference is not equal to that of uplink interference. Hence even though the channel is reciprocal, and the base station can estimate the channel, the base station cannot schedule the UE without the channel state information (CSI). If the base station obtains the CQI from the UE and uses the computed precoder at the base station, the performance can be improved (this may be referred to as a conventional method, which is a hybrid method) over a codebook-based precoding method where all the CSI is computed at the UE. However, the hybrid method may not achieve the optimal gains, because a part of the scheduling parameters is computed (Precoding) at the base station, while some other parts are computed at the UE (CQI, RI) where RI signifies Rank Indicator, and the CQI reported by the UE does not consider the precoding weights computed at the base station.

Hence, the conventional method does not provide large gains and the reciprocity-based methods are not attractive for implementation. Hence, a new solution is needed to minimize the link adaptation mismatch when the precoder is determined at the base station.

### SUMMARY

Certain aspects of the disclosure and their embodiments may provide solutions to these or other challenges. Methods are disclosed that improve the performance of the hybrid approach of computing the scheduling parameters by a two-step process, where in the first step, the base station computes the precoder based on the channel estimate from the sounding reference signal (SRS). In the second step, the base station beamforms the channel state information reference signal (CSI-RS) with the computed precoder and obtains the channel quality indicator (CQI) corresponding to the beamformed CSI-RS. However, since the transmission rank changes dynamically, instead of fixing the number of CSI-RS ports, the number of CSI-RS ports is adapted dynamically, thereby using an optimized number of resources for CSI-RS transmission. The base station indicates the number of CSI-RS ports dynamically when requesting the CQI from the UE using a downlink control channel. This is different compared to the conventional approach, where the parameters related to CSI-RS process such as number of ports etc. are pre-configured using radio resource control (RRC) signaling.

In one embodiment, methods performed by a user equipment (UE) for dynamically allocating data transmission resources in a massive multiple input multiple output (MIMO) system are disclosed. The method comprises receiving at least one initial channel state information reference signal (CSI-RS) resource set comprising at least an initial number of ports from a network node. A sounding reference signal (SRS) is transmitted to the network node. The method further comprises receiving from the network node, a dynamically allocated number of CSI-RS ports and a beamformed CSI-RS, and computing one or more parameters corresponding to channel state information (CSI) from the beamformed CSI-RS. A channel state information (CSI) report comprising the one or more parameters is transmitted to the network node. A data traffic channel is configured using the dynamically allocated number of CSI-RS ports for the user equipment (UE) to receive user data from the network node.

In one embodiment, methods performed by a network node for dynamically allocating data transmission resources in a MIMO system are disclosed. The method comprises transmitting a CSI-RS resource set comprising at least an initial number of ports to a UE. A sounding reference signal (SRS) is received from the UE. Next, a rank indicator (RI) is computed from the SRS. A number of CSI-RS ports are dynamically allocated based on the RI. The network node transmits the dynamically allocated number of CSI-RS ports and a beamformed CSI-RS to the UE. The network node also receives a channel state information (CSI) report from the UE. Finally, the network node transmits user data to the UE via a data traffic channel configured using the dynamically allocated number of CSI-RS ports.

In other embodiments, methods performed by a user equipment (UE) for dynamically allocating data transmission resources in a massive multiple input multiple output (MIMO) system are disclosed. The method comprises receiving a plurality of pre-defined channel state information reference signal (CSI-RS) resource sets, each comprising at least a number of ports, from a network node. A sounding reference signal (SRS) is then transmitted to the network node. Next, a trigger state for a pre-defined CSI-RS resource set and a beamformed CSI-RS is received from the network node. The UE computes one or more parameters corresponding to channel state information (CSI) from the beamformed CSI-RS. The UE then transmits to the network node upon receipt of a CSI request from the network node, a channel state information (CSI) report comprising the one or more parameters, wherein a data traffic channel for receiving data from the network node is configured using the pre-defined CSI-RS resource set corresponding to the trigger state received from the network node.

In these other embodiments, methods performed by a network node for dynamically allocating data transmission resources in a MIMO system are disclosed. The network node transmits a plurality of CSI-RS resource sets, each comprising at least an initial number of ports, to a UE. The network node receives a sounding reference signal (SRS) from the UE and associates a pre-defined CSI-RS resource set with a corresponding channel state information (CSI) report from the UE. The network node computes a rank indicator (RI) from the SRS and dynamically allocating a number of CSI-RS ports based on the RI. Next, the network node transmits a trigger state for a pre-defined CSI-RS resource set corresponding to the dynamically allocated number of CSI-RS ports, and a beamformed CSI-RS to the UE. The network node then receives a CSI report from the UE on the beamformed CSI-RS. Finally, the network node transmits user data to the UE via a data traffic channel configured using the dynamically allocated number of CSI-RS ports.

In one embodiment of the invention, the number of CSI-RS ports in beamformed CSI-RS based transmission is determined based on the computed rank at the base station. In the proposed method, the base station determines the number of CSI-RS ports and indicates the number to the UE for requesting the CSI. The network node uses this CSI to determine the MCS and precoding weights based on the SRS estimate and schedules the UE for Physical Downlink Shared Channel (PDSCH) transmission.

These and other embodiments disclosed herein may provide one or more of the following technical advantages. With the proposed technique the performance of reciprocity-based precoding can be improved significantly as the number of CSI-RS ports are adapted dynamically based on the rank information computed at the base station. Hence the resource utilization of CSI-RS is optimal. This improves the link throughput as these resources can be allocated for the data transmission.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an exemplary communication system in accordance with some embodiments.

FIG. 2 illustrates an exemplary user equipment in accordance with some embodiments.

FIG. 3 illustrates an exemplary network node in accordance with some embodiments.

FIG. 4 illustrates an exemplary host computer in accordance with some embodiments.

FIG. 5 illustrates a block diagram of a network function virtualization in accordance with some embodiments.

FIG. 6 illustrates a communication diagram of a host communicating via a network node with a UE over a partially wireless connection in accordance with some embodiments.

FIG. 7 illustrates an exemplary message sequence chart for downlink data transfer in 5G systems in accordance with some embodiments.

FIG. 8 shows a transmission side of an exemplary MIMO communication system with Nₜ transmit antennas in accordance with some embodiments.

FIG. 9 illustrates a graph showing link throughput using conventional reciprocity methods and beamformed CSI-RS methods with fixed CSI-RS ports in accordance with some embodiments.

FIGS. 10A and 10B illustrate exemplary diagrams of CSI-RS port configurations in accordance with some embodiments.

FIG. 11A illustrates an exemplary flow diagram of a method performed at a user equipment in accordance with some embodiments.

FIG. 11B illustrates an exemplary flow diagram of a method performed at a network node in accordance with some embodiments.

FIG. 12 illustrates an exemplary diagram illustrating a CSI reporting mechanism in accordance with some embodiments.

FIG. 13 illustrates an exemplary message sequence chart in accordance with some embodiments.

FIGS. 14A, 14B, and 14C each illustrates a graph showing the link throughput using methods of fixed and now adaptive CSI-RS ports in accordance with some embodiments.

FIG. 15 illustrates a graph of a user throughput cumulative distribution function for a system simulation in accordance with some embodiments.

FIG. 16A illustrates an exemplary flow diagram of a method performed at a user equipment in accordance with some embodiments.

FIG. 16B illustrates an exemplary flow diagram of a method performed at a network node in accordance with some embodiments.

FIG. 17 illustrates an exemplary message sequence chart in accordance with some embodiments.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the invention may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Some of the embodiments contemplated herein will now be described more fully with reference to the accompanying drawings. Embodiments are provided by way of example to convey the scope of the subject matter to those skilled in the art.

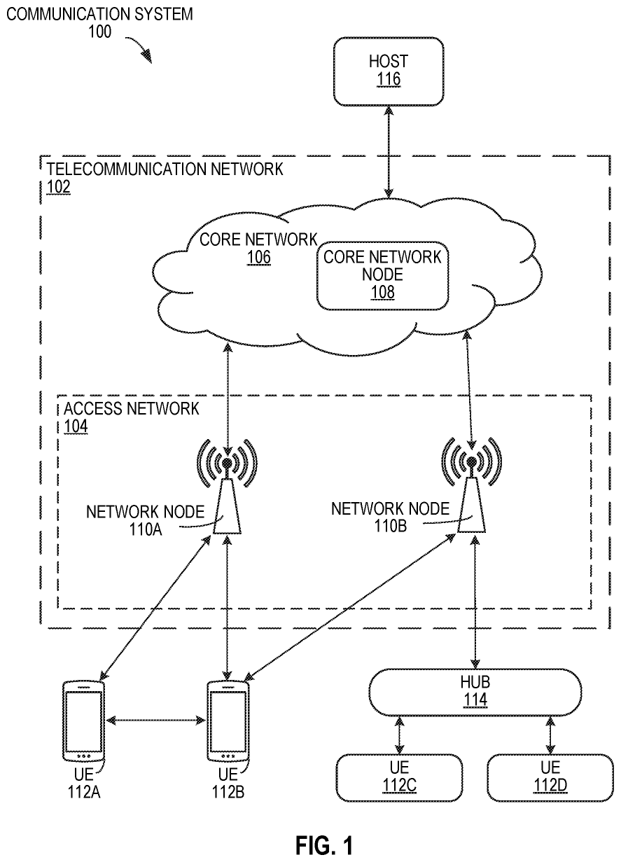

FIG. 1 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

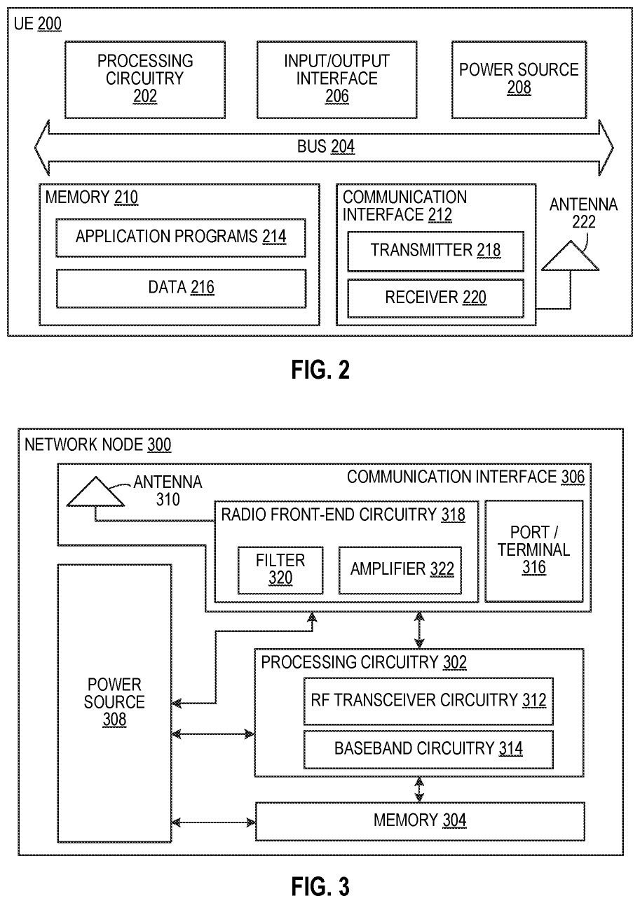

FIG. 2 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random-access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user-initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 3 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

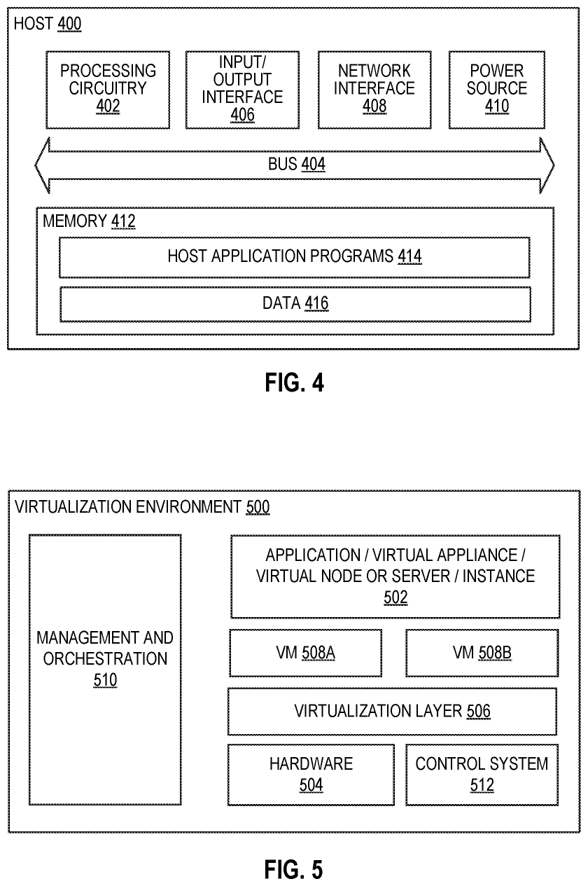

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g., such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

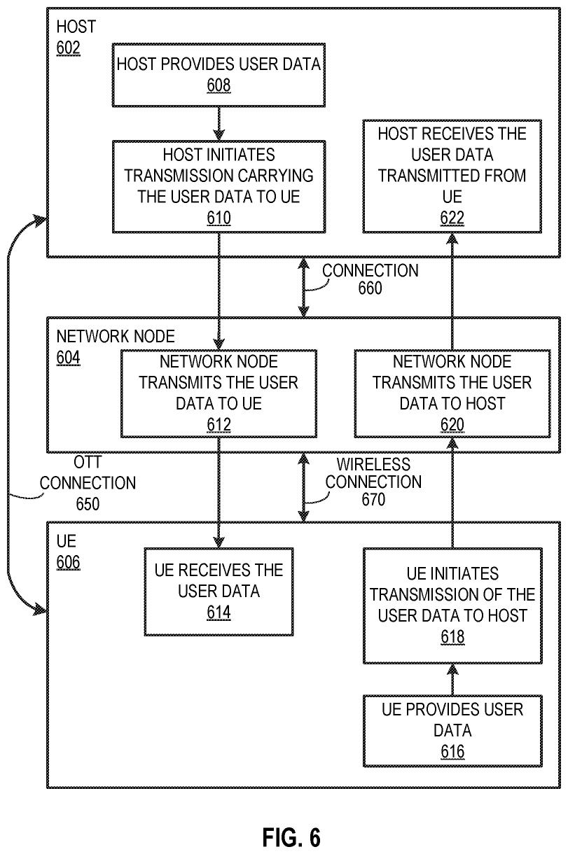

FIG. 6 shows a communication diagram of a host 602 communicating via a network node 604 with a UE 606 over a partially wireless connection in accordance with some embodiments. Example implementations, in accordance with various embodiments, of the UE (such as a UE 112a of FIG. 1 and/or UE 200 of FIG. 2), network node (such as network node 110a of FIG. 1 and/or network node 300 of FIG. 3), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the data rate and latency, and thereby provide benefits such as reduced user waiting time, relaxed restriction on file size, improved content resolution, and better responsiveness.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

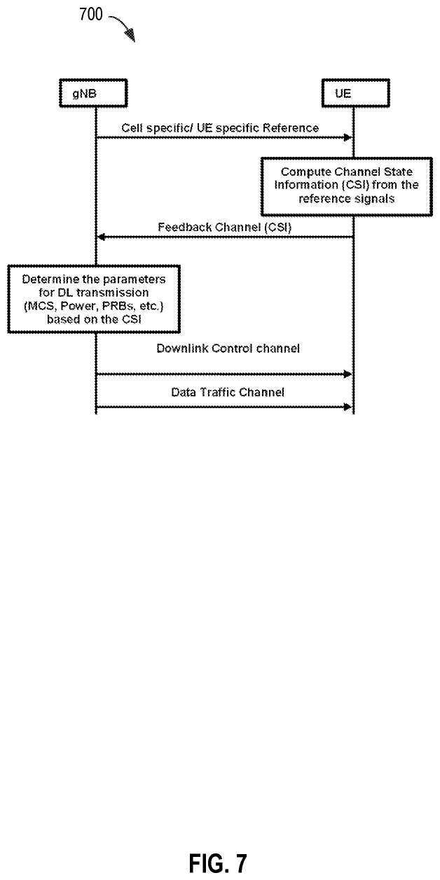

FIG. 7 shows an exemplary message sequence chart 700 for downlink data transfer in 5G systems in accordance with some embodiments. From the pilot or reference signals, the UE computes the channel estimates then computes the parameters needed for CSI reporting. The CSI report comprises, for example, the channel quality indicator (CQI), precoding matrix index (PMI), rank indicator (RI) and CSI-RS Resource Indicator (CRI, which is the same as beam indicator), etc.

The CSI report is sent to the network via a feedback channel either on request from the network a-periodically or configured to report periodically. The network scheduler uses this information in choosing the parameters for scheduling of this UE. The network sends the scheduling parameters to the UE in the downlink control channel. After that actual data transfer takes place from network to the UE.

Downlink reference signals are predefined signals occupying specific resource elements within the downlink time-frequency grid. There are several types of downlink reference signals that are transmitted in different ways and used for different purposes by the receiving UE:

CSI reference signals (CSI-RS): These reference signals are specifically intended to be used by UEs to acquire channel-state information (CSI) and beam specific information (beam RSRP). In 5G CSI-RS is UE-specific so it can have a significantly lower time/frequency density.

Demodulation reference signals (DM-RS): These reference signals, also sometimes referred to as UE-specific reference signals, are specifically intended to be used by UEs for channel estimation for data channel. The label “UE-specific” relates to the fact that each demodulation reference signal is intended for channel estimation by a single UE. That specific reference signal is then only transmitted within the resource blocks assigned for data traffic channel transmission to that UE.

The uplink control channel carries information about HARQ-ACK (Hybrid Automatic Repeat Request Acknowledgement) corresponding to the downlink data transmission, and channel state information. The channel state information typically consists of CRI, RI, CQI, PMI, and Layer Indicator etc. The CSI can be divided into two categories. One is for subband, and the other is for wideband. The configuration of subband or wideband CSI reporting is done through RRC signaling as part of CSI reporting configuration. Table 1 shows the contents of a CSI report for PMI format indicator=Wideband, CQI format indicator=wideband, and for PMI format indicator=subband, CQI format indicator=subband.

TABLE 1
Contents of CSI report for both wideband and subband

| PMI-FormatIndicator = | PMI-FormatIndicator = subbandPMI or | | |
|---|---|---|---|
| widebandPMI and | CQI-FormatIndicator = subbandCQI | | |
| CQI-FormatIndicator = | | CSI Part II | |
| widebandCQ | CSI Part I | wideband | Subband |
| CRI | CRI | Wideband CQI | Subband differential |
| | | for the second | CQI for the second TB |
| | | TB | of all even subbands |
| Rank Indicator | Rank Indicator | PMI wideband | PMI subband |
| | | (X1 and X2) | information fields |
| | | | X₂ of all even |
| | | | subbands |
| Layer Indicator | Layer Indicator | — | Subband differential |
| | | | CQI for the second TB |
| | | | of all odd subbands |
| PMI wideband | Wideband CQI | — | PMI subband |
| (X1 and X2) | | | information fields |
| | | | X₂ of all odd |
| | | | subbands |
| Wideband CQI | Subband | — | — |
| | differential CQI for | | |
| | the first transport | | |
| | block (TB) | | |

Note that for NR, the subband is defined according to the bandwidth part of the Orthogonal Frequency Division Multiplexing (OFDM) in terms of Physical Resource Blocks (PRBs) as shown in Table 2.

TABLE 2
Configurable subband sizes

| Carrier bandwidth part (PRBs) | Subband Size (PRBs) |
|---|---|
| <24 | N/A |
| 24-72 | 4, 8 |
| 73-144 | 8, 16 |
| 145-275 | 16, 32 |

The subband configuration is also done through RRC signaling. Note that the network can indicate whether the UE should report all the CSI entities such as CRI, RI, PMI, and CQI or only some entities such as CQI and RI, CQI, RI and PMI, etc.

The downlink control channel (e.g., the Physical Downlink Control Channel (PDCCH)) carries information about the scheduling grants. Typically, this comprises the number of MIMO layers scheduled, transport block sizes, modulation for each codeword, parameters related to HARQ, subband locations, etc. Note that all downlink control information (DCI) formats may not transmit all the information as shown above and described below. In general, the contents of the PDCCH depends on the transmission mode and DCI format.

Typically, the following information may be transmitted by means of the downlink control information (DCI) format:
Carrier indicator
Identifier for DCI formats
Bandwidth part indicator
Frequency domain resource assignment
Time domain resource assignment
VRB (Virtual Resource Block)-to-PRB mapping flag
PRB bundling size indicator
Rate matching indicator
ZP (Zero Power) CSI-RS trigger
Modulation and coding scheme for each TB
New data indicator for each TB
Redundancy version for each TB
HARQ process number
Downlink Assignment Index
TPC (Transmit Power Control) command for uplink control channel
PUCCH resource indicator
PDSCH-to-HARQ feedback timing indicator
Antenna port(s)
Transmission configuration indication
SRS request
CBG (Code Block Group) transmission information
CBG flushing out information
DMRS sequence initialization

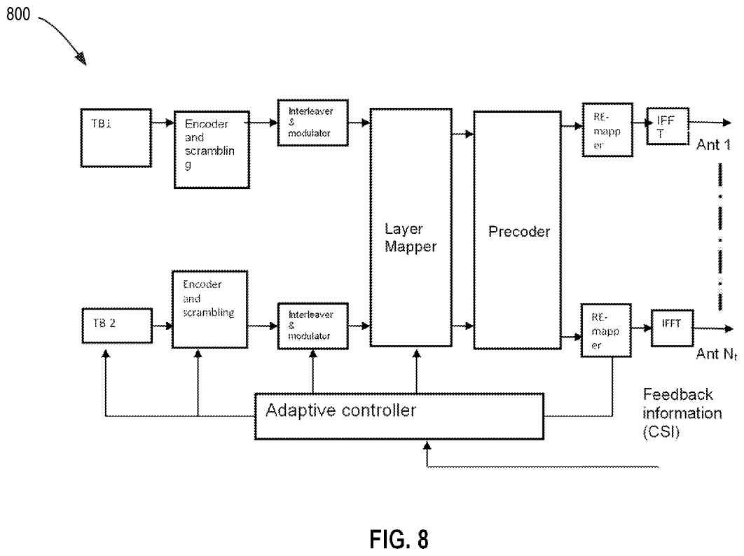

FIG. 8 shows a transmission side 800 of an exemplary MIMO communication system with Nₜ transmit antennas in accordance with some embodiments. There are up to 2 transport blocks (TBs) where the number of transport blocks is equal to one when the number of layers is less than or equal to 4. If the number of layers is more than 4, then 2 transport blocks are transmitted. The cyclic redundancy check (CRC) bits are added to each transport block and passed to the channel encoder. Low density parity check codes (LDPC) are the forward error correction (FEC) for NR. The channel encoder adds parity bits to protect the data. After encoding, the data stream is scrambled with user-specific scrambling. Then the stream is passed through an interleaver. The interleaver size is adaptively controlled by puncturing to increase the data rate. The adaptation is done by using the information from the feedback channel, for example channel state information sent by the receiver. The interleaved data is passed through a symbol mapper (modulator). The symbol mapper is also controlled by the adaptive controller. After the modulator, the streams are passed through a layer mapper and the precoder. The resultant symbols are mapped to the resource's elements in the time-frequency grid of OFDM (Orthogonal Frequency Division Multiplexing). The resultant streams are then passed through an inverse fast Fourier transform (IFFT) block. An IFFT block is necessary for some communication systems which implement OFDMA as the access technology (e.g., 5G, LTE/LTE-A); in other systems, it might be different and is dependent on the multiple access system. The encoded stream is then transmitted through the respective antenna.

The precoding is applied at the base station to achieve the beamforming gain. When the channel is not known such as in FDD systems, the base station obtains the precoding index from the UE. In TDD systems where the uplink channel can be estimated at the base station, the precoding index is obtained through a sounding reference signal. Due to reciprocity, the downlink channel is equal to the uplink channel, and the precoding matrix/vector can be obtained from the channel estimation at the base station.

In reciprocity-based precoding, mathematically, the received signal can be written as: Y=HWx+n, where H is the channel matrix between the transmitter antenna elements of dimensions (Nᵣ×Nₜ), W is the digital precoding matrix of dimensions (Nₜ×R), x is the transmitted signal vector of size (R×1), and R is the transmission rank of the system.

For reciprocity-based systems W=V, where V is computed from: SVD(H)=UDV′

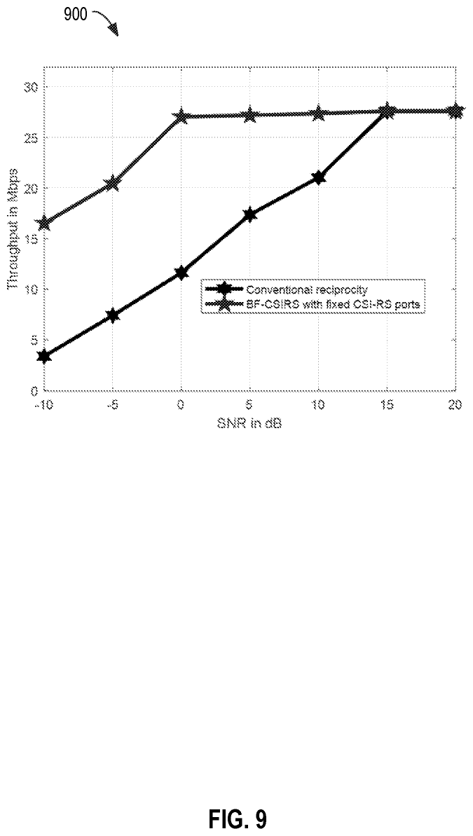

However, the performance can be improved if the base station computes the precoder based on the channel estimate from the SRS. The base station beamforms the CSI-RS with the computed precoder and obtains the CQI corresponding to the beamformed CSI-RS. FIG. 9 illustrates an exemplary graph 900 showing the link throughput versus Signal-to-Noise Ratio (SNR) obtained by using a beamformed CSI-RS method compared to the conventional reciprocity method for antenna configuration of (2,8) that is 2 rows and 8 columns with cross polarization.

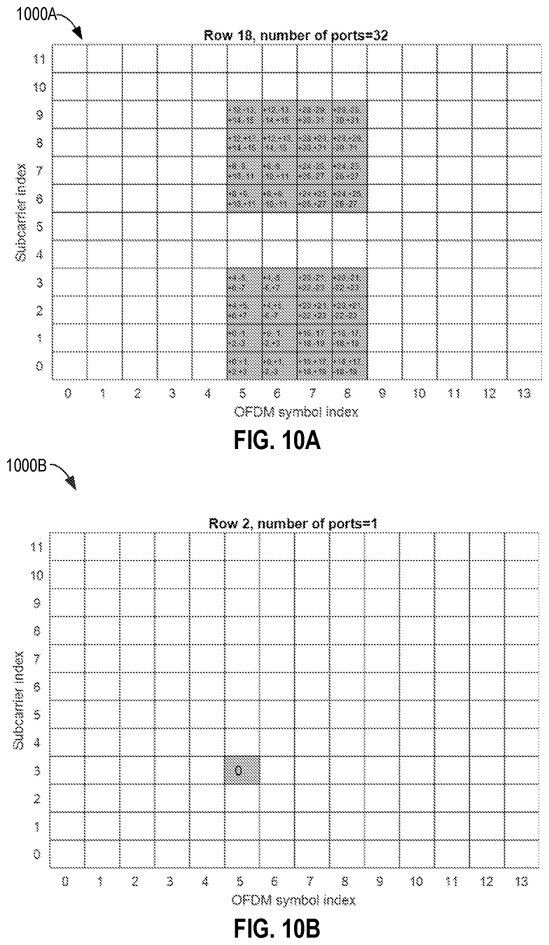

However, in the beamformed CSI-RS method, the number of CSI-RS ports are RRC configured to a fixed value. Hence, if the transmission rank is equal to one, for example, then fixing the number of CSI-RS ports to a fixed value, say 32, is not efficient as the number of resources occupied by 32 ports is very high compared to a single port as shown in FIGS. 10A and 10B. In diagram 1000A of FIG. 10A it can be observed that the overhead for 32 ports is 19% of the total resource elements in a resource block, while as shown in diagram 1000B of FIG. 10B, for a single port the overhead is 0.6%. Hence with the conventional method where the fixed number of ports is 32 but transmission rank is one, 31/32 or about 96.9% of the configured resources are wasted as the number of ports is fixed to a constant value using RRC signaling. Hence, new solutions disclosed herein are needed to optimize the resource allocation when using beam formed CSI-RS for reciprocity-based massive MIMO systems.

In embodiments of the invention disclosed herein, methods to improve the performance of a reciprocity-based massive MIMO system using a two-step process are disclosed. In the first step, the base station computes the precoder based on the channel estimate from the SRS. In the second step, the base station beamforms the CSI-RS with the computed precoder and obtains the CQI corresponding to the beamformed CSI-RS. However, since the transmission rank changes dynamically, instead of fixing the number of CSI-RS ports using RRC signaling, the number of CSI-RS ports are adapted dynamically thereby using an optimized number of resources for CSI-RS transmission. The base station indicates the number of CSI-RS ports dynamically by triggering the corresponding CSI resource setting for requesting the CQI from the UE using a downlink control channel. This is different compared to a conventional approach, where the parameters related to CSI-RS process such as number of ports etc. are pre-configured using RRC signaling.

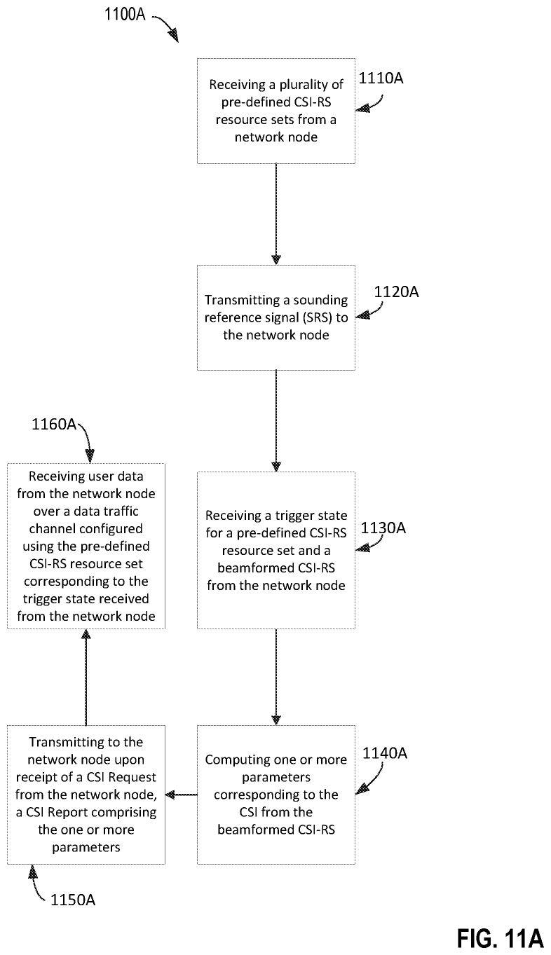

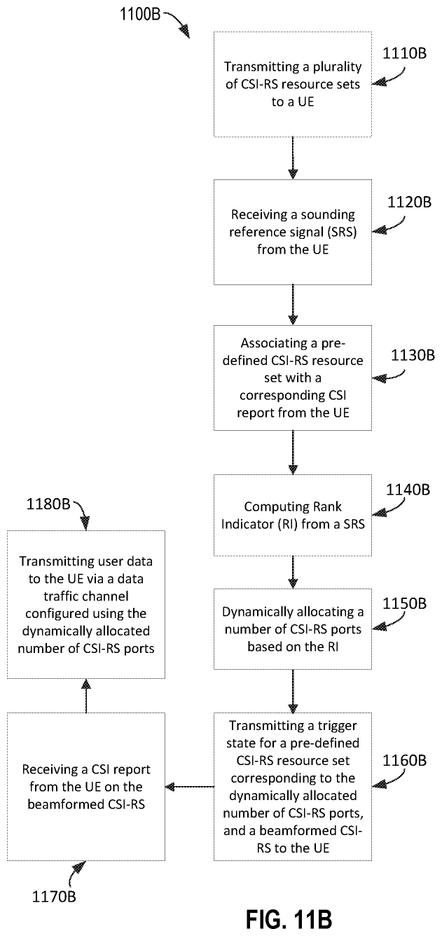

On the UE side, embodiments of the disclosed invention may perform steps as shown in flow diagram 1100A of FIG. 11A, including: in order to initiate configuration by the network node about the CSI-RS resource, first receiving a plurality of pre-defined channel state information reference signal (CSI-RS) resource sets, each comprising at least a number of ports, from a network node at step 1110A. A sounding reference signal (SRS) is transmitted from the UE to the network node at step 1120A. At step 1130A, a trigger state for a pre-defined CSI-RS resource set and a beamformed CSI-RS is received from the network node. At step 1140A, one or more parameters corresponding to channel state information (CSI) are computed from the beamformed CSI-RS. Upon receipt of a CSI request from the network node, a channel state information (CSI) report comprising the one or more parameters is transmitted to the network node at step 1150A. Next, at step 1160A, a data traffic channel for receiving data from the network node is configured using the pre-defined CSI-RS resource set corresponding to the trigger state received from the network node.

Embodiments of the invention which can be applied at the network node may include performing steps as shown in flow diagram 1100B of FIG. 11B. In step 1110B, a plurality of pre-defined CSI-RS (for example, 3) resource sets are transmitted to a UE. An SRS is received from the UE at step 1120B. At step 1130B, pre-defined CSI-RS resource sets are associated with a corresponding CSI report from the UE. The rank indicator is computed from the SRS estimate received from the UE or from the UE feedback at step 1140B. At step 1150B, the number of CSI-RS ports is dynamically allocated based on (e.g., set equal to) the rank indicator computed at the network node. At step 1160B, the network node transmits a trigger state for a pre-defined CSI-RS resource set corresponding to the dynamically allocated number of CSI-RS ports, and a beamformed CSI-RS to the UE. At step 1170B, the CSI report from the UE is then received on the beamformed CSI-RS. User data is then transmitted to the UE via a data traffic channel configured using the dynamically allocated number of CSI-RS ports at step 1180B.

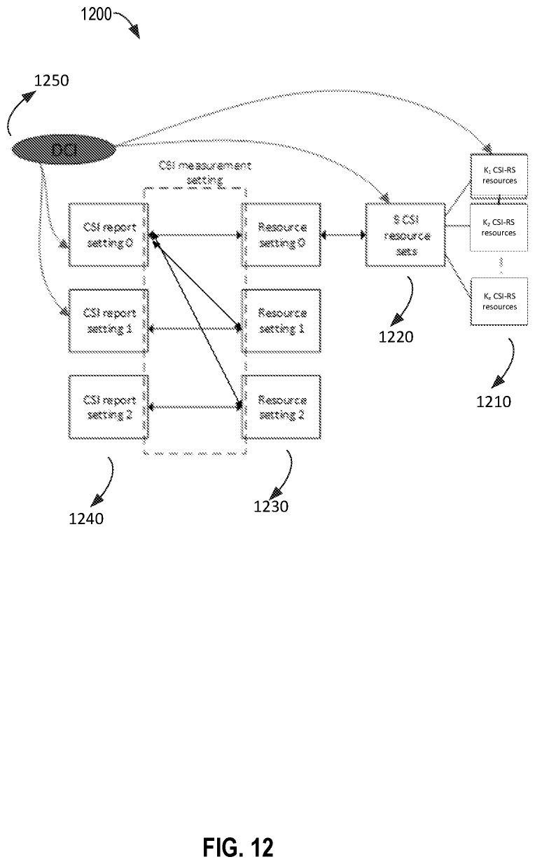

A diagram 1200 depicting an exemplary CSI reporting mechanism featuring multiple CSI-RS resources is shown in FIG. 12. Downlink control information DCI at 1250 carries control information used to schedule user data, including channel state information (CSI). DCI needs to be decoded in order to decode downlink data or transmit uplink data. Channel State Information Reference Signal (CSI-RS) is a reference signal (RS) that is used in the Downlink (DL) direction in 5G NR, for the purpose of channel sounding and used to measure the characteristics of a radio channel so that it can use correct modulation, code rate, beam forming etc. (e.g., a CSI resource). A CSI-RS resource set may be set to a resource setting which may be configured per device. UEs will use these CSI-RS reference signals to measure the quality of the DL channel and report this in the uplink (UL) direction.

The network node (gNB) sends CSI-RS reports to report channel status information such as CSI-RSRP, CSI-RSRQ and CSI-SINR for mobility procedures. Specific instances of CSI-RS report settings can be configured for time/frequency tracking and mobility measurements, for example. Channel state information (CSI) is the way of indicating certain reports by the UE to the network. These reports may include well-defined reporting parameters such as: Channel Quality Indicator (CQI), Precoding Type Indicator (PTI), Precoding Matrix Indicator (PMI), Rank Indicator (RI), and Layer Indicator (LI).

A number of CSI-RS resources 1210 may be organized into a number of CSI resource sets 1220. Resource settings 1230 may be correlated with one or more CSI report settings 1240.

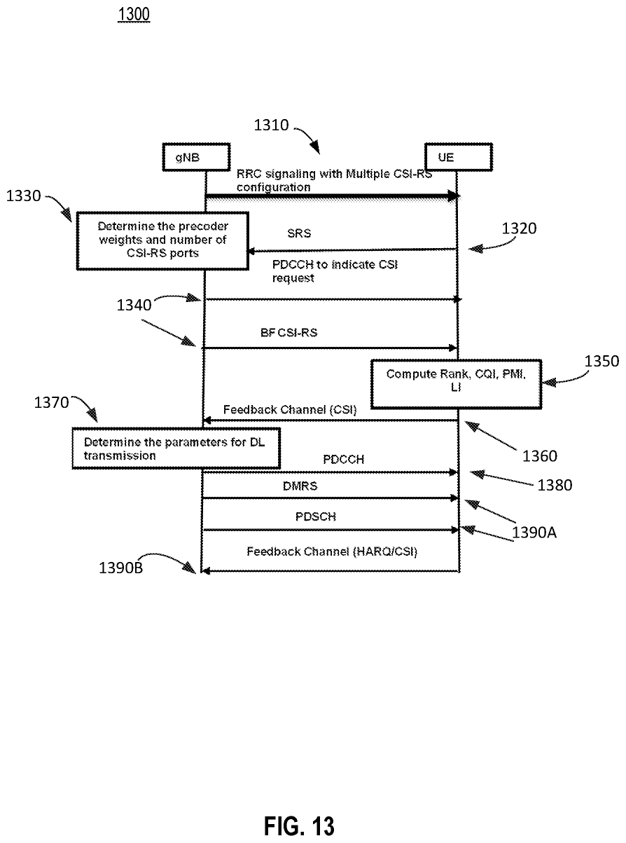

FIG. 13 illustrates an exemplary message sequence chart 1300 in accordance with some embodiments. In the first step 1310, the gNB, via RRC signaling, configures the UE with multiple CSI-RS resource configuration (e.g., 3) with the number of ports equal to 1, 2, and 4 (say). In general, these values depend on the UE capability to support N layers. Also, the gNB configures the UE with CSI report settings where the reporting quantities and their time domain properties are indicated. In addition, the gNB sends the parameters related to the SRS transmission received from the UE at step 1320. In particular, during the uplink slot, the gNB estimates the channel between the UE and the network node from the received SRS, as computed at step 1330. In particular, from the estimated channel, the gNB computes the precoder weights and the temporary rank indicator, RIₜ, at 1330, and transmits this to the UE, to receive a CSI via feedback channel at step 1360. For beamformed CSI-RS transmission at step 1340, the number of CSI-RS ports may be set to RIₜ. To obtain the CSI from the UE with the beamformed CSI-RS, the gNB needs to inform the UE about the updated number of CSI-RS ports (RIₜ). In some embodiments, this is indicated via downlink control channel using PDCCH for requesting the CSI by indicating one of the CSI-RS resource setting (triggering states) at step 1340. The UE computes the CSI using this beamformed CSI-RS at step 1350. Note that the UE might report all or only partial CSI as configured by the RRC signaling at the beginning. The UE reports the CSI using PUCCH and/or PUSCH at step 1360. Once the gNB receives the CSI, it will determine the scheduling parameters for downlink data transmission at step 1370. As is known in the art, the gNB indicates the scheduling parameters to the UE at step 1380 as part of the downlink control channel using PDCCH. Then the actual data transmission takes place using DMRS and PDSCH at step 1390A, with a feedback from UE at step 1390B.

With the proposed techniques the performance of reciprocity-based precoding can be improved significantly as the number of CSI-RS ports are adapted dynamically based on the rank indicator computed at the base station. Hence the resource utilization of CSI-RS is optimal. This improves the link throughput as these resources can be allocated for the data transmission.

The following describes the method at the network node to compute the number of CSI-RS ports for beamformed CSI-RS transmission in accordance with some embodiments. For the method to work, first the network node needs to identify the number of ports for beamformed CSI-RS. In one embodiment, the network uses the information it obtained from the UE with the initial number of CSI-RS ports configured by the network node that is the CSI obtained from the UE with N number of ports. This is because the rank indicator is computed over the wideband and does not change so often. Hence keeping the rank indicator obtained from the UE for choosing CSI-RS ports for beamformed CSI-RS may be effective, as the UE knows the interference and a UE-reported rank is more trustable. In addition, the network node can allocate a maximum number of CSI-RS ports (equal to a maximum supported rank by the UE), after a certain time interval (periodically), to avoid sending CSI-RS with a lower number of ports thanks to the rank supported by the UE at that time instance. That is, periodically it can set the number of ports equal to the maximum number of layers the UE can support.

In another embodiment, the network node can obtain the number of CSI-RS ports for beamformed CSI-RS from the SRS channel estimate. For example, the channel matrix estimated at the network node is, for example, H_SRS, e.g., of dimensions Nₜ×Nᵣ, where Nₜ is the number of receive antennas at the network node and Nᵣ is the number of transmit antennas at the UE side. Then using the singular value decomposition (SVD) of the Hermitian of the SRS estimate

$$[ U D {V}^{′} ] = S V D ( {H\_SRS}^{′} )$$

where H_SRS is the wideband channel estimate obtained from the SRS estimate.

The number of CSI-RS ports for beamformed CSI-RS is obtained by significant values for eigen values of main diagonal. For example, only choose the values which are greater than a pre-defined threshold. In one embodiment of the disclosed invention, the rank at the network node (e.g., gNB) may be estimated from the eigenvalues of the channel matrix. If the eigenvalues are small, the rank may be 1 or 2 for a 4×4 matrix. If the eigenvalues are larger, the rank may be 4.

The following describes the method at the network node to compute the precoder weights for beamformed CSI-RS transmission in accordance with some embodiments. Once the number of CSI-RS ports are decided by the network node, the network node needs to identify the precoding matrix for beamformed CSI-RS. There are multiple methods for how the network node can determine the precoder weights from the channel estimation from the SRS. In one method, the network node can use singular value decomposition (SVD) of the channel matrix with a specific granularity say 4 physical resource blocks (PRB), or 2 PRB and determine the precoder weights. In another embodiment the network node uses minimum mean square error (MMSE) criteria or zero forcing (ZF) criteria to obtain the precoder matrix. These and other methods are described, for example, in texts such as Digital Communications, 5^{th} Edition, by John G. Proakis and Masoud Salehi (2007).

The following describes the method to signal the updated number of CSI-RS ports and the request to transmit the CSI in accordance with some embodiments. Once the number of CSI-RS ports are decided by the network node, the network node needs to inform the updated CSI-RS ports to the UE for CSI request from the UE. Note that since the number of CSI-RS ports changes dynamically, it can be informed to the UE using downlink control channel and can indicate whether the CSI is aperiodic or periodic or semi persistent. Once the network indicates the number of CSI-RS ports to the UE and the CSI request, the network transmits the beamformed CSI-RS, where the CSI-RS is multiplied with the precoder weights computed in above. Note that, this step may require modification of 3GPP TS 38.212 standard, as in the existing specification the UE can't report CSI, say 3 port CSI-RS. Hence for this method to work, the UE and the network node may need to use the same codebook with the same number of CSI-RS ports.

The following describes methods at the UE to compute the channel state information using beamformed CSI-RS transmission in accordance with some embodiments. Once the UE gets information from the network about the updated CSI-RS ports, it computes the CSI report settings which will maximize the link capacity, and reports the settings to the network node. In one embodiment the UE reports RI and CQI only. In another embodiment the UE computes the RI, PMI and CQI. Note that when the UE reports the PMI, the network node needs to update the precoder matrix for data transmission as the UE computes the CQI based on the effective channel.

To verify the benefits of some embodiments of the disclosed methods, the performance of a NR massive MIMO system with link level simulations is evaluated. A MIMO system with 32 ports (2 rows and 8 columns Advanced Antenna Systems (AAS)) and the UE capable of receiving 32 ports are considered with link adaptation, where the rank information, precoding information, modulation, coding rate/transport block size are dynamically updated for each slot. The simulations assume practical channel estimation from the SRS for computing the precoding matrix at the network node. For link adaptation using CSI, UE chooses the PMI, RI and CQI based on maximization of mutual information. The feedback is assumed to have 4 slots delay and is assumed to be error free. Simulations are run for a UE with different SNRs, and the wireless channel assumed is Clustered Delay Line (CDL)-A channel. The velocity of the UE is assumed to be 3 Kmph. The main simulation parameters are tabulated in Table 3.

TABLE 3
Detailed link level simulation assumptions

| Assumptions | Value |
|---|---|
| Carrier frequency | 3.5 GHz |
| Duplex | TDD with DDDSU |
| System Bandwidth | 10 MHz |
| Slot length | 1 ms |
| Subcarrier spacing | 15 KHz |
| Guard time interval | 4.7 us (interval of LTE normal CP) as baseline |
| FFT size | 2048 |
| Data transmission | 624 subcarriers for 15 KHZ spacing |
| bandwidth | |
| Antenna configuration | (2, 8, 2) |
| Number of codewords | 1 |
| Precoding codebook | NR Type-1 |
| Channel encoder | LDPC code with 25 iterations |
| MCS | For link adaptation: QPSK, 16-QAM 64 QAM |
| | and 256-QAM are considered with variable |
| | code rate |
| Control Overhead | 2 symbols |
| Channel estimation | Practical at gNB and UE |
| DMIRS configuration | 1 + 1 Type 1 |
| PMI / rank feedback | Baseline: 0% |
| error rate | |
| CQI feedback error rate | Baseline: 0% |
| Feedback delay | 4 slots |
| Channel Model | CDL channel model according to the 3GPP TR |

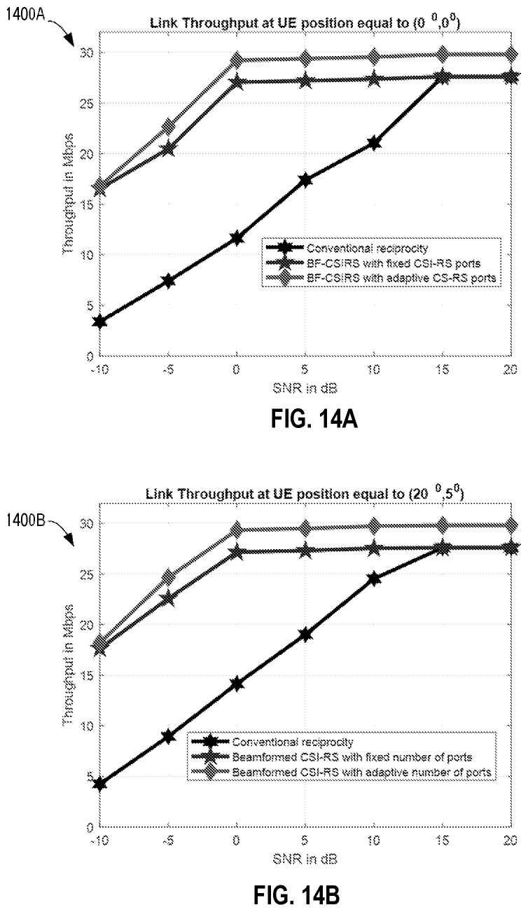

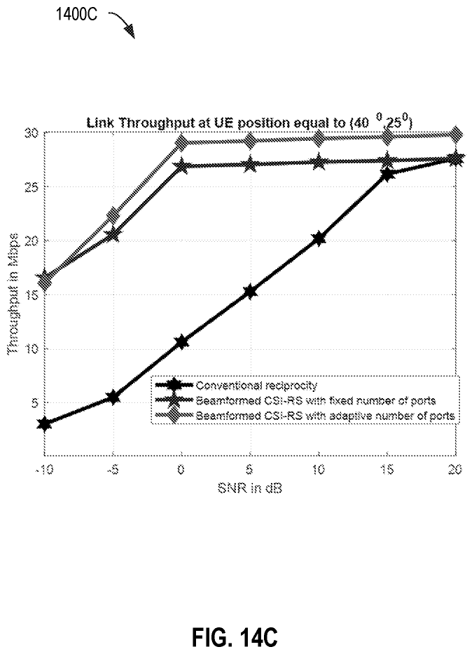

FIG. 14A depicts graph 1400A showing the link throughput with the disclosed method of adaptive CSI-RS ports. The UE position with respect to the base station is 0 degrees in azimuthal and 0 degrees elevation. For comparison purposes, the throughput with beamformed CSI-RS transmission with fixed number of CSI-RS ports equal to 32 was also plotted, as well as the conventional reciprocity method where the precoder is computed at the network node, while the CQI is computed on the non-beamformed CSI-RS. It can be observed that the significant gains can be achieved with the proposed method as the number of resources are adapted according to the number of CSI-RS transmitted.

FIGS. 14B and 14C depict graph 1400B showing the link throughput at UE locations 20⁰ in azimuthal and 5⁰ elevation and graph 1400C showing the link throughput at UE locations 40⁰ in azimuthal and 25⁰ elevation respectively. In these cases, too, it can be observed that significant gains can be obtained with the proposed method.

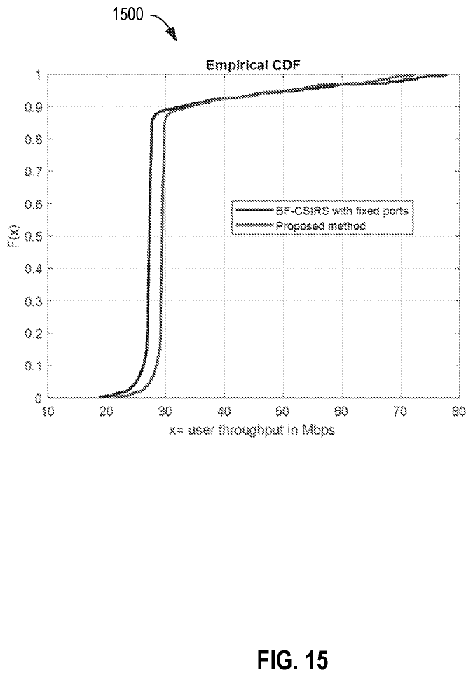

To verify the benefits of the disclosed method, the performance of a NR massive MIMO system is evaluated with system level simulations. Similar to link level, a MIMO system with 32 ports (2 rows and 8 columns AAS) and the UE capable of receiving 32 ports are considered with link adaptation, where the rank information, precoding information, modulation, coding rate/transport block size are dynamically updated for each slot. The system simulation assumptions are shown in Table 4. FIG. 15 shows the user throughput cumulative distribution function (CDF) for the disclosed methods obtained using a system simulator. It can be observed that significant gains can be obtained using the disclosed methods.

TABLE 4
System simulation assumptions.

| Parameter | Value | |
|---|---|---|
| Number of tri-sectored cells | 19 | |
| BS-to-BS distance | 500 | m |
| Minimum BS-to-UE distance | 35 | m |
| BS transmit power | 46 | dBm |
| Shadowing standard deviation | 8 | dB |
| BS shadowing correlation | 0.5 | |
| BS noise figure | 5 | dB |
| BS antenna gain | 14 | dB |
| BS antenna radiation pattern | 5G channel | |
| | model | |
| UE antenna gain | 0 | dB |
| UE other losses | 20 | dB |

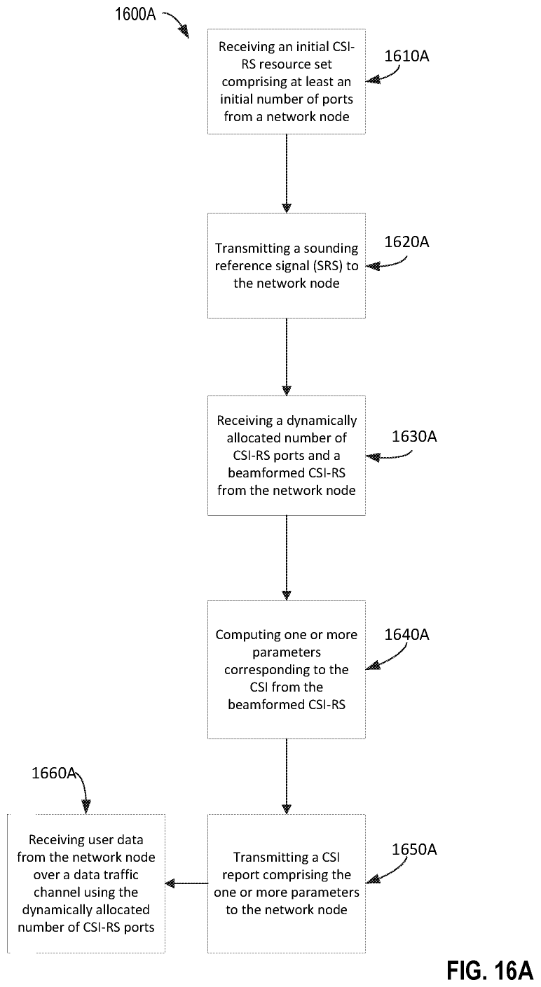

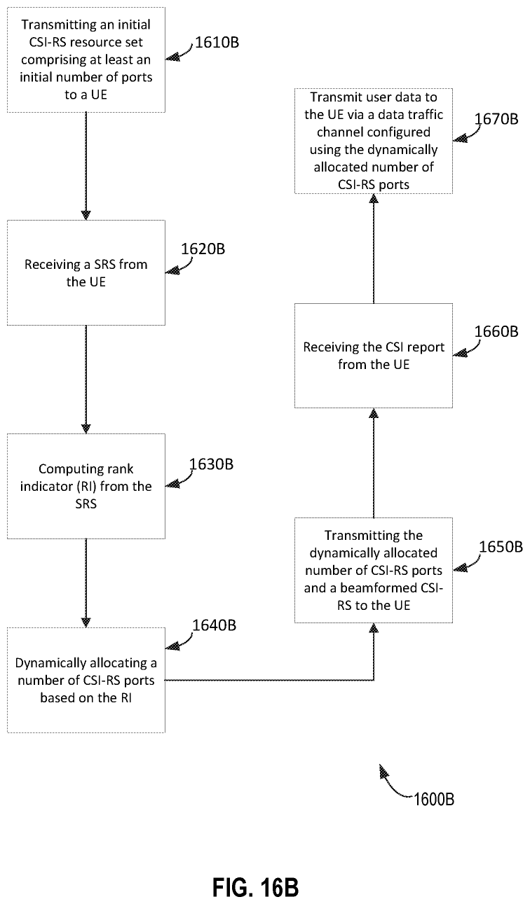

FIG. 16A illustrates an exemplary flow diagram 1600A of a method performed at a user equipment in accordance with some embodiments. At step 1610A, a UE receives an initial CSI-RS resource set based on a computed precoded matrix, where the initial CSI-RS resource set comprises at least an initial number of ports from a network node. At step 1620A, the UE transmits a sounding reference signal (SRS) to the network node. The UE then receives a dynamically allocated number of CSI-RS ports and a beamformed CSI-RS from the network node in step 1630A. At step 1640A, one or more parameters corresponding to the CSI from the beamformed CSI-RS are computed at the UE. At step 1650A, the one or more parameters are reported to the network node, which will then determine the scheduling parameters for downlink data transmission. At step 1660A, the UE receives user data from the network node over a data traffic channel using the dynamically allocated number of CSI-RS ports.

FIG. 16B illustrates an exemplary flow diagram 1600B of a method performed at a network node in accordance with some embodiments. At step 1610B, a network node transmits an initial CSI-RS resource set comprising at least an initial number of ports to a UE. At step 1620B, the network node receives an SRS from the UE. At step 1630B, the network node computes an initial rank indicator (RI) from the SRS. The network node dynamically allocates a number of CSI-RS ports based on the RI at step 1640B. At step 1650B, the dynamically allocated number of CSI-RS ports and a beamformed CSI-RS are transmitted to the UE. At step 1660B, the network node receives the CSI report from the UE. Once the network node receives the CSI report, at step 1670B, the network node may initiate data transmission to the UE via a data traffic channel configured using the dynamically allocated number of CSI-RS ports.

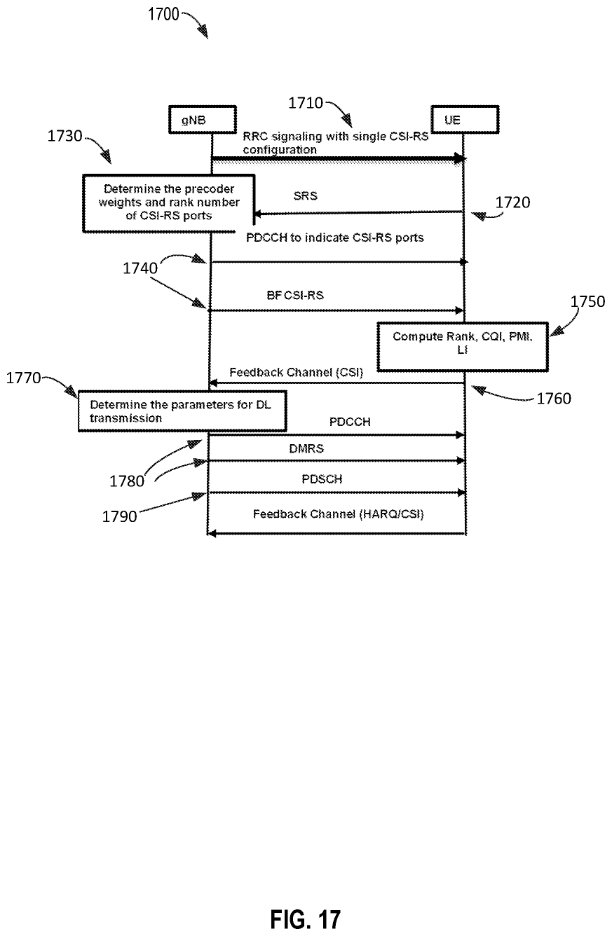

FIG. 17 illustrates an exemplary message sequence chart 1700 in accordance with some embodiments. FIG. 17 describes a method using a multi-step procedure for transmitting data to the UE using reciprocity-based precoding. In the first step 1710, the gNB, via RRC signaling, configures the UE with a single CSI-RS resource configuration with initial number of ports (for example, N). In general, N depends on the UE capability and the gNB capability. In addition, the gNB sends the parameters related to the SRS transmission received from the UE at step 1720. During the uplink slot, the gNB estimates the channel between the UE and the network node from the received SRS. From the estimated channel, the gNB computes the precoder weights and the temporary rank number at step 1730, where the temporary rank number may be designated as RIₜ. For beamformed CSI-RS transmission, the number of CSI-RS ports can be set to RIₜ. To obtain the CSI from the UE with the beamformed CSI-RS, the gNB needs to inform the UE about the updated number of CSI-RS ports (RIₜ) which is different from the original number of ports (N). At step 1740, this may be indicated via downlink control channel using PDCCH for requesting the CSI. At step 1750, the UE computes the CSI (e.g., Rank, CQI, PMI, and LI) using the beamformed CSI-RS, which was also received from the gNB at step 1740. Note that at step 1760, the UE might report all or only partial CSI as configured by the RRC signaling at the beginning. The UE reports the CSI using PUCCH and/or PUSCH at step 1760. Once the gNB receives the CSI, it will determine the scheduling parameters for downlink data transmission at step 1770. As in conventional procedure, the gNB indicates the scheduling parameters as part of downlink control channel using PDCCH at step 1780, and the actual data transmission takes place using DMRS and PDSCH at step 1790.

The method at the network node to compute the number of CSI-RS ports for beamformed CSI-RS transmission, the methods to signal the updated number of CSI-RS ports, and the request to transmit the CSI are performed similarly as has been described above. Further, the methods at the UE to compute the channel state information using beamformed CSI-RS transmission are also performed similarly as has been described above.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3^{rd} Generation Partnership Project
4G 4^{th} Generation
5G 5^{th} Generation
6G 6^{th} Generation
ABS Almost Blank Subframe
ACK Acknowledgement
ARQ Automatic Repeat Request
AWGN Additive White Gaussian Noise
BCCH Broadcast Control Channel
BCH Broadcast Channel
BS Base Station
BSC Base Station Controller
CA Carrier Aggregation
CC Carrier Component
CCCH SDU Common Control Channel SDU
CDMA Code Division Multiplexing Access
CDMA2000 Code Division Multiple Access 2000
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality Indicator
CRC Cyclic Redundancy Check
C-RNTI Cell RNTI
CSI Channel State Information
D2D Device-to-Device
DCCH Dedicated Control Channel
DCI Downlink Control Index
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB (Evolved Node B, base station)
ePDCCH Enhanced Physical Downlink Control Channel
EDGE Enhanced Data rates for GSM Evolution
E-SMLC Evolved Serving Mobile Location Center
E-UTRA Evolved UTRA (Universal Terrestrial Radio Access)
E-UTRAN Evolved UTRAN (Universal Terrestrial Radio Access Network)
E-UTRA FDD E-UTRA Frequency Division Duplex
E-UTRA TDD E-UTRA Time Division Duplex
FDD Frequency Division Duplex
FFS For Further Study
gNB Base station in NR
GERAN GSM EDGE Radio Access Network
GSM Global System for Mobile Communications
HARQ Hybrid Automatic Repeat Request
HD Half Duplex
HO Handover
HRPD High Packet Rate Data
HSDPA High Speed Downlink Packet Access
HSPA High Speed Packet Access
HRPD High Rate Packet Data
LOS Line of Sight
LPP LTE Positioning Protocol
LTE Long-Term Evolution
M2M Machine-to-Machine
MAC Medium Access Control
MAC Message Authentication Code
MAP Maximum Aposteriori Probability
MBSFN Multimedia Broadcast Multicast Service Single Frequency Network
MBSFN ABS MBSFN Almost Blank Subframe
MDT Minimization of Drive Tests
MIB Master Information Block
MIMO Multiple Input Multiple Output
ML Maximum Likelihood
MME Mobility Management Entity
MMSE Minimum Mean Square Error
MSC Mobile Switching Center
MTC Machine-Type Communication
NAK Non-Acknowledgement
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PCI Precoding Control Index
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRB Physical Resource Block
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RB Resource Block
RE Resource Element
RS Resource Signal
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
   Reference Signal Received Power
RSRQ Reference Signal Received Quality OR
   Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SINR Signal-to-Interference Ratio
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
Tx Transmitter
UE User Equipment
UL Uplink
USIM Universal Subscriber Identity Module
UTRA Universal Terrestrial Radio Access
UTRA FDD UTRA Frequency Division Duplex
UTRA TDD UTRA Time Division Duplex
UTDOA Uplink Time Difference of Arrival
WCDMA Wide CDMA
WLAN Wide Local Area Network
ZF Zero Forcing

1-8. (canceled)

9. A method performed by a network node for dynamically allocating data transmission resources in a massive multiple input multiple output (MIMO) system, the method comprising:
transmitting a channel state information reference signal (CSI-RS) resource set comprising at least an initial number of ports to a user equipment (UE);
receiving a sounding reference signal (SRS) from the UE;
computing a rank indicator (RI) from the SRS;
dynamically allocating a number of CSI-RS ports based on the RI;
transmitting the dynamically allocated number of CSI-RS ports and a beamformed CSI-RS to the UE;
receiving a channel state information (CSI) report from the UE; and
transmitting user data to the UE via a data traffic channel configured using the dynamically allocated number of CSI-RS ports.

10. The method of claim 9, wherein the number of dynamically allocated CSI-RS ports is selected from any one of 1, 2, 3 or 4 ports.

11. The method of claim 9, further comprising the step of identifying a reciprocity-based precoding matrix.

12. The method of claim 11, wherein the precoding matrix is obtained using minimum mean square error (MMSE) or ZF (Zero Forcing).

13. The method of claim 11, further comprising the step of determining precoder weights of the precoding matrix using singular value decomposition (SVD) of a channel matrix obtained based on the SRS.

14. The method of claim 9, wherein the CSI report is received via one or more of a physical uplink control channel (PUCCH) and a physical uplink scheduling channel (PUSCH).

15. The method of claim 9, wherein the dynamically allocated number of CSI-RS ports is transmitted as a downlink control index (DCI) field value comprising either a 1-bit or a 2-bit value.

16. The method of claim 9, wherein the dynamically allocated number of CSI-RS ports is transmitted to the UE via a physical downlink control channel (PDCCH).

17. The method of claim 9, further comprising:
determining one or more scheduling parameters for downlink data transmission to the UE; and
transmitting the one or more scheduling parameters via a physical downlink control channel (PDCCH).

18. The method of claim 9, wherein the network node is configured to receive the CSI report from the UE either periodically, aperiodically, or semi-persistently.

19-26. (canceled)

27. A method performed by a network node for dynamically allocating data transmission resources in a massive multiple input multiple output (MIMO) system, the method comprising:
transmitting a plurality of pre-defined channel state information reference signal (CSI-RS) resource sets, each comprising at least an initial number of ports, to a user equipment (UE);
receiving a sounding reference signal (SRS) from the UE;
associating a pre-defined CSI-RS resource set with a corresponding channel state information (CSI) report from the UE;
computing a rank indicator (RI) from the SRS;
dynamically allocating a number of CSI-RS ports based on the RI;
transmitting a trigger state for a pre-defined CSI-RS resource set corresponding to the dynamically allocated number of CSI-RS ports, and a beamformed CSI-RS to the UE;
receiving a CSI report from the UE on the beamformed CSI-RS; and
transmitting user data to the UE via a data traffic channel configured using the dynamically allocated number of CSI-RS ports.

28. The method of claim 27, further comprising the step of identifying a reciprocity-based precoding matrix.

29. The method of claim 28, wherein the precoding matrix is obtained using minimum mean square error (MMSE) or ZF (Zero Forcing).

30. The method of claim 29, further comprising the step of determining precoder weights of the precoding matrix using singular value decomposition (SVD) of a channel matrix obtained based on the SRS.

31. The method of claim 27, wherein the CSI report is received via one or more of a physical uplink control channel (PUCCH) and a physical uplink scheduling channel (PUSCH).

32. The method of claim 27, further comprising:
determining one or more scheduling parameters for downlink data transmission to the UE; and
transmitting the one or more scheduling parameters via a physical downlink control channel (PDCCH).

33. The method of claim 27, further comprising the step of estimating a data transmission channel between the UE and the network node from the received SRS.

34. The method of claim 33, wherein the number of CSI-RS ports dynamically allocated by the network node for beamformed CSI-RS is based on the estimated data transmission channel.

35. The method of claim 33, wherein the estimated data transmission channel comprises a channel matrix H_SRS estimated at the network node and having dimensions Nₜ×Nᵣ, where Nₜ is the number of receive antennas at the network node and Nᵣ is the number of transmit antennas at the UE, and the number of CSI-RS ports dynamically allocated by the network node for beamformed CSI-RS comprises a quantity of one or more eigen values of a main diagonal of a singular value decomposition (SVD) of a Hermitian matrix of the channel matrix H_SRS, wherein each of the one or more eigen values is greater than a pre-defined threshold.

36. (canceled)

37. A network node for dynamically allocating data transmission resources in a massive multiple input multiple output (MIMO) system, the network node comprising:
processing circuitry configured to perform the following operations:
transmitting a channel state information reference signal (CSI-RS) resource set comprising at least an initial number of ports to a user equipment (UE);
receiving a sounding reference signal (SRS) from the UE;
computing a rank indicator (RI) from the SRS;
dynamically allocating a number of CSI-RS ports based on the RI;
transmitting the dynamically allocated number of CSI-RS ports and a beamformed CSI-RS to the UE;
receiving a channel state information (CSI) report from the UE; and
transmitting user data to the UE via a data traffic channel configured using the dynamically allocated number of CSI-RS ports; and
power supply circuitry configured to supply power to the processing circuitry.
